(19) United States
(12) Patent Application Publication
(10) Pub. No.: US 2026/0027929 A1
(43) Pub. Date: Jan. 29, 2026

(54) ARRANGEMENT FOR INCREASING THE RANGE OF AN ELECTRICALLY DRIVEN VEHICLE COMBINATION

(71) Applicant: ZF CV Systems Global GmbH, Bern (CH)

(72) Inventor: Johannes Heseding, Hannover (DE)

(21) Appl. No.: 19/351,130

(22) Filed: Oct. 6, 2025

Related U.S. Application Data
(63) Continuation of application No. PCT/EP2024/059700, filed on Apr. 10, 2024.

(30) Foreign Application Priority Data
Apr. 14, 2023 (DE) 10 2023 109 452.1

(51) Int. Cl. B60L 53/30; B60L 53/53; B60L 53/62

(52) U.S. Cl. CPC B60L 53/30; B60L 53/53; B60L 53/62; B60L 2210/10; B60L 2250/16

(57) ABSTRACT

An arrangement is for increasing the range of an electrically driven vehicle combination. The arrangement includes a power adaptation and charging control unit for bidirectionally transmitting voltage between a first high-voltage battery of a towing vehicle of the vehicle combination and a second high-voltage battery of a trailer of the vehicle combination.

### CROSS-REFERENCE TO RELATED APPLICATIONS

This application is a continuation application of international patent application PCT/EP2024/059700, filed Apr. 10, 2024, designating the United States and claiming priority from German application 10 2023 109 452.1, filed Apr. 14, 2023, and the entire content of both applications is incorporated herein by reference.

### TECHNICAL FIELD

The disclosure relates to an arrangement for increasing the range of an electrically driven vehicle combination.

### BACKGROUND

Commercial vehicle combinations are known that are electrically driven. An electric drive positioned in a tractor unit of the vehicle combination is supplied with power by a high-voltage battery, which is also placed in the tractor unit. Since the range of the vehicle combination is limited by the capacity of the high-voltage battery, trailers for the tractor unit are known that have an additional electric drive and thus extend the range of the vehicle combination without an electrical coupling to the tractor unit.

### SUMMARY

It is an object of the disclosure to overcome the disadvantages of the prior art, in particular to provide an arrangement that increases the range of the vehicle combination in as many situations as possible.

This object is, for example, achieved by way of an arrangement for increasing the range of an electrically driven vehicle combination according to the disclosure. According to various embodiments, the arrangement for increasing the range of an electrically driven vehicle combination includes a power adaptation and charging control unit for bidirectionally transmitting energy between a high-voltage battery of a towing vehicle of the vehicle combination and a high-voltage battery of a trailer of the vehicle combination. The power adaptation and charging control unit can be used to take energy from the high-voltage battery of the trailer and supply it to the high-voltage battery of the towing vehicle via a simple high-voltage connection in the form of a plug-in cable. However, there is also the possibility of the first high-voltage battery of the towing vehicle using the power adaptation and charging control unit to charge the second high-voltage battery of the trailer. The high-voltage connection between the towing vehicle and the trailer can be of inexpensive configuration in the form of a plug-in cable. As a result, a range extension can be achieved while the electrically driven vehicle combination is moving.

In an embodiment, the power adaptation and charging control unit has a DC/DC power converter for adapting the voltage level of the first high-voltage battery of the towing vehicle and of the second high-voltage battery of the trailer and a charge controller for directly charging the second high-voltage battery of the trailer. The first and second high-voltage batteries can carry different high voltages on account of different operating conditions, for example different temperatures or loads. The DC-DC power converter is used in this case to compensate for the high voltages for the transfer of energy that is to be carried out, in order to prevent considerable compensation currents that damage the first and/or the second high-voltage battery from being able to flow between the first and second high-voltage batteries without any energy flow regulation owing to the minimal resistance of the high-voltage cable in the event of voltage differences of a few volts.

The charge controller encompasses the function of charging the second high-voltage battery of the trailer using a combined charging system (CCS) protocol. From the point of view of the second high-voltage battery of the trailer, the power adaptation and charging control unit including the charge controller acts as if it were connected directly to an external charging post. In particular, installation effort and costs are reduced if the charge controller is an integrated part of the DC/DC power converter and therefore only one component has to be handled.

In another embodiment, the DC/DC power converter is of Dc-isolating configuration. Since the towing vehicle is meant to be coupled to the trailer via the plug-in high-voltage connection, the DC-isolating DC/DC power converter ensures that even people who are not trained to handle high voltages can make this plug-in connection without injury. The DC-isolating DC/DC power converter ensures that no hazardous voltages are accessible, or present on the terminals, on the tractor unit in the unplugged condition.

In another embodiment, the charge controller is coupled to a master battery management unit for controlling the transmission of energy between the first high-voltage battery of the towing vehicle and the second high-voltage battery of the trailer. The master battery management unit can also be an integral part of the DC-isolating DC/DC power converter including the charge controller, thereby further reducing outlay on parts for the arrangement. The master battery management unit is firstly an information interface to the towing vehicle to collect aggregated information about the condition of the high-voltage system of the vehicle combination, such as state of charge, fault conditions, overall range, et cetera. Secondly, the master battery management unit suitably shapes the control of the flow of energy between the first and second high-voltage batteries. It takes the DC voltage stored in the first high-voltage battery of the towing vehicle and the energy extracted from the first high-voltage battery by the drive present in the towing vehicle as a basis for calculating the DC voltage that needs to be selected from the second high-voltage battery of the trailer. The energy that is actually stored in the second high-voltage battery of the trailer is ignored for this calculation.

In another embodiment, the second high-voltage battery of the trailer has a slave battery management unit for selecting the transmission of energy on the second high-voltage battery, which slave battery management unit is connected to the master battery management unit via an electrical signal line. The slave management battery unit undertakes compensation for the voltages at the level of the individual battery cells of the second high-voltage battery. In addition, the slave battery management unit evaluates the measuring devices of the individual battery cells with regard to current and voltage and the interconnections thereof and provides this information for the master battery management unit.

In another embodiment, the power adaptation and charging control unit is a part of the high-voltage battery control and charging system of the towing vehicle. This compact high-voltage battery control and charging system can be used to produce a transfer of energy from the trailer to the towing vehicle in exactly the same way as in the opposite direction from the towing vehicle to the trailer.

In another embodiment, the trailer has multiple high-voltage batteries assembled to form a high-voltage battery pack, each high-voltage battery of the high-voltage battery pack of the trailer having a slave battery management unit for selecting the transmission of energy to or from the respective high-voltage battery. All of the slave battery management units are coupled to the master battery management unit in the tractor unit via an electrical signal line. The master battery management unit monitors the currents and voltages in the individual high-voltage batteries of the high-voltage battery pack of the trailer. If necessary, differences in the voltages between the individual high-voltage batteries of the high-voltage battery pack are balanced out, this being performed in combination with the slave battery management units provided for each high-voltage battery of the high-voltage battery pack.

In another embodiment, the signal line is routed to a distributor unit connecting the flow of signals and the flow of energy on the trailer, the signal line branching from the distributor unit to the various slave battery management units. The distributor unit connects not only the flow of signals between the towing vehicle and the trailer, but also the flow of energy, to the individual high-voltage batteries of the high-voltage battery pack.

In another embodiment, contactors for enabling the flow of energy from and to the high-voltage battery pack of the trailer are arranged in the distributor unit of the trailer, the contactors being controllable by the master battery management unit of the power adaptation and charging control unit. To ensure electrical safety, a signal from the master battery management unit must be present in order to engage the contactor. Only then is transmission of energy enabled. Only when the high-voltage connection is plugged in and the flow of signals between the master battery management unit and the slave battery management units is unimpeded is the high voltage connected to the plugged-in high-voltage connection via the contactors.

In another embodiment, a second DC-isolating DC/DC power converter is positioned on the trailer. This second DC-isolating DC/DC power converter ensures touch safety redundantly in addition to the contactors.

In another embodiment, a charging connection element is configured for external energy intake by the vehicle combination for the high-voltage battery of the towing vehicle or the high-voltage battery pack of the trailer. Just one charging point can be used to charge all of the high-voltage batteries of the entire vehicle combination.

In another, embodiment, the master battery management system is connectable to a driver information system for centrally displaying operating and/or diagnostic data. The driver of the vehicle combination can thus be promptly advised of any faults and can take measures to put an end to the faults.

### BRIEF DESCRIPTION OF DRAWINGS

The invention will now be described with reference to the drawing wherein:

FIG. 1 shows a block diagram of a vehicle combination including an embodiment of the arrangement according to the disclosure.

### DETAILED DESCRIPTION

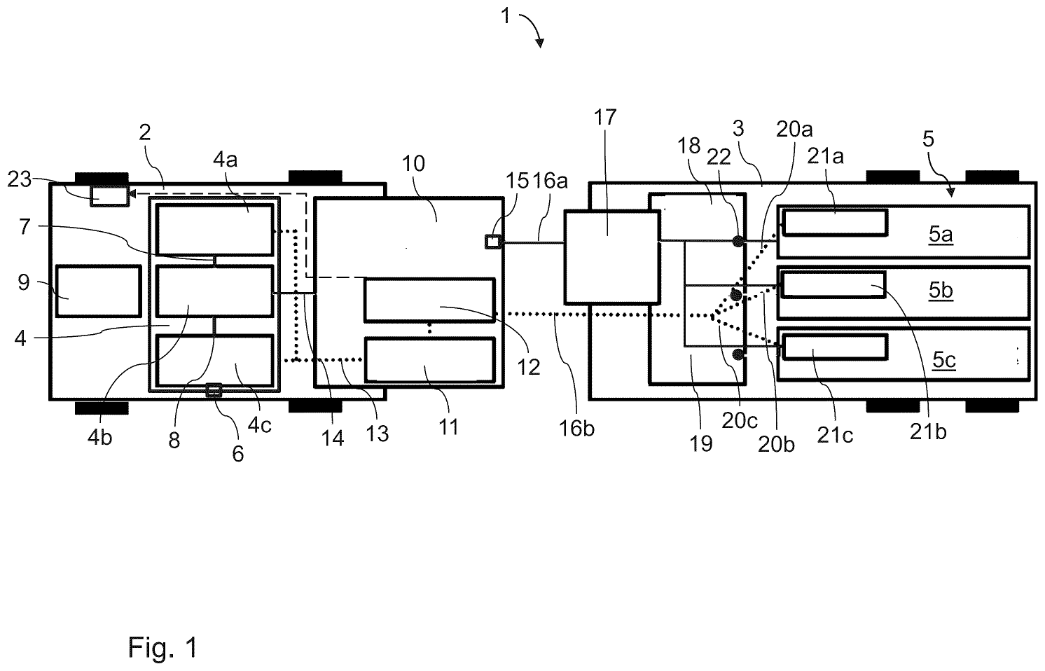

FIG. 1 shows a block diagram of a vehicle combination including an embodiment of the arrangement according to the disclosure. The vehicle combination 1, for example a heavy commercial vehicle combination, includes an electrically driven towing vehicle 2 and a trailer 3. In addition to the high-voltage battery system 4 of the towing vehicle 2, the trailer 3 is equipped with a high-voltage battery pack 5, which in the present case includes three high-voltage batteries 5a, 5b, 5c. The high-voltage battery control and charging system 4 of the towing vehicle 2 includes a high-voltage battery 4a, a first distributor unit 4b and a charge controller 4c, the charge controller 4c being connected to a plug-in connection 6 for an external battery charging cable. The three parts 4a, 4b, 4c of the high-voltage battery control and charging system 4 are connected to one another via high-voltage cables 7, 8. The high-voltage battery control and charging system 4 is used to supply an electric drive 9 of the towing vehicle 2 with power.

The first distributor unit 4b of the high-voltage battery control and charging system 4 is coupled to a DC-isolated DC/DC power converter 10 that is placed in the towing vehicle 2. The DC isolation in this case is ensured by way of a transformer, for example. In addition to this function, the DC/DC power converter 10 includes a charge controller 11, which operates according to a standardized CCS protocol and the charging process of which is controlled by a master battery management controller 12, which is also positioned within the DC/DC power converter 10. The charge controller 11 is linked to the high-voltage battery 4a and the charge controller 4c of the high-voltage battery control and charging system 4 of the towing vehicle 2 via a first signal line 13, while the first distributor unit 4b of the high-voltage battery control and charging system 4 of the towing vehicle 2 is coupled to the DC-isolated DC/DC power converter 10 via a first high-voltage cable 14. An output of the DC/DC power converter 10 has a connector holder 15, into which a connecting line 16 for the trailer 3 is plugged. This connecting line 16 includes a high-voltage connection 16a as well as a signal connection 16b.

On the trailer 3, the connecting line 16 is routed to a main contact unit 17, which is a part of a second distributor unit 18 of the trailer 3. In this second distributor unit 18, a second high-voltage cable 19 is split into the high-voltage sub-cables 19, each of the high-voltage sub-cables 19 being routed to one of the high-voltage batteries 5a, 5b, 5c of the high-voltage battery pack 5. The signal connection 16b also connects the master battery management controller 12 to the second distributor unit 18 and, in the second distributor unit 18, branches into three signal sub-lines 20a, 20b, 20c, each of which is coupled to a slave battery management controller 21a, 21b, 21c of a high-voltage battery 5a, 5b, 5c of the high-voltage battery pack 5.

The DC/DC power converter 10 including the integrated charge controller 11 and the likewise integrated master battery management controller 12 ensures the exchange of energy between the high-voltage battery 4a of the towing vehicle 2 and the high-voltage battery pack 5 of the trailer 3. The charging process for transmitting power from the high-voltage battery pack 5 of the trailer 3 to the high-voltage battery 4a of the towing vehicle 2, which charging process proceeds on the basis of a standardized CCS protocol, is controlled via the master battery management controller 12 in exactly the same way as a transmission of power in the opposite direction from the high-voltage battery 4a of the towing vehicle 2 to the high-voltage battery pack 5 of the trailer 3 via the connecting line 16a.

To transmit signals, the master battery management controller 12 communicates with the slave battery management controllers 21a, 21b, 2c of the trailer 3 via the signal line 16b. In this case, the master battery management controller 12 undertakes control of the transmission of power as well as collection of information about the condition of the high-voltage system of the entire vehicle combination 1. In coordination with the master battery management controller 12, the slave battery management controllers 21a, 21b, 21c undertake compensation for the high voltages at the cell level of the individual high-voltage batteries 5a, 5b, 5c of the high-voltage battery pack 5 of the trailer 3.

In addition, the use of the DC-isolated DC/DC power converter 10 also takes into account safety aspects for the plug-in high-voltage connection 16a, thereby preventing hazardous high voltages from being present on the terminals of the plug-in connection 15 in an unplugged condition.

In an alternative to the illustration described, the DC-isolated DC/DC power converter 10 including the charge controller 11 and the battery management controller 12 can be positioned on the trailer 3, the main contact unit 17 being a part of the first distributor unit 4b of the towing vehicle 2.

It is understood that the foregoing description is that of the preferred embodiments of the invention and that various changes and modifications may be made thereto without departing from the spirit and scope of the invention as defined in the appended claims.

### REFERENCE SIGNS

1 vehicle combination
2 towing vehicle
3 trailer
4 high-voltage battery control and charging system of the towing vehicle
4a high-voltage battery
4b distributor unit
4c battery charge controller
5 high-voltage battery pack of the trailer
5a high-voltage battery
5b high-voltage battery
5c high-voltage battery
6 plug-in connection
7 high-voltage cable
8 high-voltage cable
9 electric drive
10 DC/DC power converter
11 charge controller
12 master battery management controller
13 signal line
14 high-voltage cable
15 connector holder
16 connecting line
16a high-voltage connection
16b signal connection
17 main contact unit
18 distributor unit of the trailer
19 high-voltage cable
20a signal sub-line
20b signal sub-line
20c signal sub-line
21a slave battery management controller
21b slave battery management controller
21c slave battery management controller
22 contactor
23 driver information system

1. An arrangement for increasing the range of an electrically driven vehicle combination, the arrangement comprising:
a power adaptation and charging control unit configured for bidirectionally transmitting voltage between a first high-voltage battery of a towing vehicle of the electrically driven vehicle combination and a second high-voltage battery of a trailer of the electrically driven vehicle combination.

2. The arrangement of claim 1, wherein the power adaptation and charging control unit has a DC/DC power converter for adapting the voltage level of the first high-voltage battery of the towing vehicle and of the second high-voltage battery of the trailer and a charge controller for directly charging the second high-voltage battery of the trailer.

3. The arrangement of claim 2, wherein the DC/DC power converter is of DC-isolating configuration.

4. The arrangement of claim 2, wherein the charge controller is an integrated part of the DC/DC power converter.

5. The arrangement of claim 2, wherein the charge controller is coupled to a master battery management unit of the power adaptation and charging control unit for controlling a transmission of energy between the first high-voltage battery of the towing vehicle and the second high-voltage battery of the trailer.

6. The arrangement of claim 5, wherein the second high-voltage battery of the trailer has a slave battery management unit for selecting a transmission of energy on the second high-voltage battery, which slave battery management unit is connected to the master battery management unit via an electrical signal line.

7. The arrangement of claim 1, wherein the power adaptation and charging control unit is a part of a high-voltage battery control and charging system of the towing vehicle.

8. The arrangement of claim 1, wherein the trailer has multiple high-voltage batteries assembled to form a high-voltage battery pack, each of the multiple high-voltage batteries of the high-voltage battery pack of the trailer having a slave battery management unit for selecting a transmission of energy to or from the respective high-voltage battery, all of which are coupled to a master battery management unit in the towing vehicle via an electrical signal line.

9. The arrangement of claim 8, wherein the electrical signal line is routed to a distributor unit connecting a flow of signals and a flow of energy in the trailer and branches from the distributor unit to the various slave battery management units.

10. The arrangement of claim 7, wherein a plurality of contactors for enabling a flow of energy from and to the high-voltage battery pack of the trailer are arranged in a distributor unit of the trailer, the plurality of contactors being controllable by a master battery management unit of the power adaptation and charging control unit.

11. The arrangement of claim 2, wherein a second DC-isolating DC/DC power converter is positioned on the trailer.

12. The arrangement of claim 1, wherein a charging connection element is configured for external energy intake for the vehicle combination on a high-voltage battery control and charging system of the towing vehicle.

13. The arrangement of claim 1, wherein a master battery management system is connectable to a driver information system for centrally displaying at least one of operating data and diagnostic data.
